(19) United States
(12) Patent Application Publication
(10) Pub. No.: US 2021/0094064 A1
(43) Pub. Date: Apr. 1, 2021

(54) MAGNETIC PAINTING TEMPLATE FOR SHOOTING TARGET

(71) Applicant: Qingdao Senwode Electrical and Mechanical Co., Ltd., Qingdao (CN)

(72) Inventor: Yingchun ZHAO, Qingdao (CN)

(21) Appl. No.: 16/589,449

(22) Filed: Oct. 1, 2019

(51) Int. Cl. B05C 17/06; F41J 1/00

(52) U.S. Cl. CPC B05C 17/06; F41J 1/00

(57) ABSTRACT

The invention provides a magnetic painting template for a shooting target, which has an improved template structure and is composed of a plurality of concentric graphical bodies and linear bodies radiating outward from the center of the circle, wherein blank areas among the concentric graphical bodies are to be painted for suiting target plates with different specifications, and a magnetic member is additionally mounted so that the template is adsorbed on a target plate by the magnetic member, thus a vertical or planar target plate can be quickly fixed without manual support, avoiding the movement of the template and spraying errors due to human factors.

### FIELD OF THE INVENTION

The invention relates to a shooting training device, and particularly to a magnetic painting template for a shooting target.

### BACKGROUND OF THE INVENTION

Nowadays, since more and more people like shooting sports, there are also target plates with various specifications on the market, wherein patterns on target rings of shooting target plates are usually sprayed by painting templates, but most of the painting templates are only applicable to target plates with one specification, and target rings formed by spraying are undesirable when such painting templates are used for other smaller or larger target plates. In addition, most spraying templates require manual support or the aid of other instruments to be vertically fixed, and therefore need to be improved due to their cumbersome operation, poor stability, and susceptibility to being hindered by fixing members such as bolts of target plates.

### SUMMARY OF THE INVENTION

In view of the above, an object of the invention is to provide a magnetic painting template for a shooting target to solve at least one of the above problems.

The invention adopts the following technical solution:

A magnetic painting template for a shooting target comprises a mesh frame body and a magnetic member mounted on the body, wherein the mesh frame body comprises a plurality of concentric graphical bodies which are tapered from the outside to the inside and linear bodies which are radiating outward from the center of the circle.

The magnetic painting template has an improved template structure and is composed of a plurality of concentric graphical bodies and linear bodies radiating outward from the center of the circle, wherein blank areas among the concentric graphical bodies are to be painted, and since a plurality of the concentric graphical bodies are included, a user can select the blank area in the outer periphery of the specific-diameter concentric graphical body to be painted based on the size of a target ring, thus suiting target plates with different specifications.

The concentric graphical bodies include concentric annular bodies, concentric rectangular bodies or graphical bodies of other shapes.

In addition, since a magnetic member is additionally mounted, for a target plate made of metal such as iron, the template is adsorbed on the target plate by the magnetic member, thus a vertical or planar target plate can be quickly fixed without manual support, avoiding the movement of the template and spraying errors due to human factors.

The body is made of a hard material including metal such as iron or steel, or a flexible material such as a flexible plastic or rubber.

The magnetic member is made of a soft magnetic material which is for example sprayed on the mesh frame body, or a hard magnetic material which is prepared in a block shape and mounted on the concentric graphical bodies or the radiating linear bodies. Of course, the soft magnetic material can also be prepared in a block shape and mounted on the concentric graphical bodies or the radiating linear bodies.

When the soft or hard magnetic material is prepared into a block shape, the block-shaped magnetic member is fixed by holes provided on the concentric graphical bodies or the radiating linear bodies.

To further improve the applicability of the template to target plates such as a target plate hanging from a target holder, the target plate is generally fixed on the target holder by bolts or other fixing members, but the bolts or other fixing members may hinder the placement of the template if not removed. In this template, the linear bodies extending radially outward from the center of the circle are separated into a plurality of segments by the concentric graphical bodies, and in the remaining linear bodies excluding at least one linear body, respective ends of the segments between the adjacent concentric graphical bodies are disconnected from the neighboring concentric graphical body, and the other respective ends thereof are connected to the neighboring concentric graphical body.

The concentric graphical bodies and/or the radiating linear bodies are made of flexible materials such as rubber and flexible ABS plastics.

The integrity of the mesh frame body is maintained by one linear body, and respective ends of the segments of the remaining linear bodies are disconnected from the neighboring concentric graphical body, for example, lower ends of the segments of the linear bodies are disconnected from the neighboring concentric graphical body, or upper ends thereof are disconnected from the neighboring concentric graphical body, so that the included angle between planes of the adjacent concentric graphical bodies can be adjusted under an external force. For example, when the position of the outermost concentric graphical body is adjusted by manually lifting up the outermost concentric graphical body, the included angle between planes of the outermost concentric graphical body and the adjacent concentric graphical body can be gradually increased from 0°, thereby avoiding contacting fixing members such as bolts of a target plate.

In further optimization, the outermost concentric graphical body is provided with a handle, and more preferably, the handle is provided with a hole.

The handle facilitates a painter to adjust the position of the template, and the hole provided on the handle facilitates hanging and storage.

### BRIEF DESCRIPTION OF THE DRAWINGS

FIG. 1 is a structural view of Embodiment 1 of the template;

FIG. 2 is a structural view of Embodiment 2 of the template;

FIG. 3 is a structural view A of Embodiment 3 of the template; and

FIG. 4 is a structural view B of Embodiment 3 of the template.

In the Figures: 1. mesh frame body; 2. magnetic member; 3. handle; 11. concentric graphical body; 12. linear body; 31. hole; 121. segment.

### DETAILED DESCRIPTION OF THE INVENTION

Particular embodiments of the invention will be further described below in detail with reference to the drawings so as to make the technical solution of the invention easier to understand and grasp.

### Embodiment 1

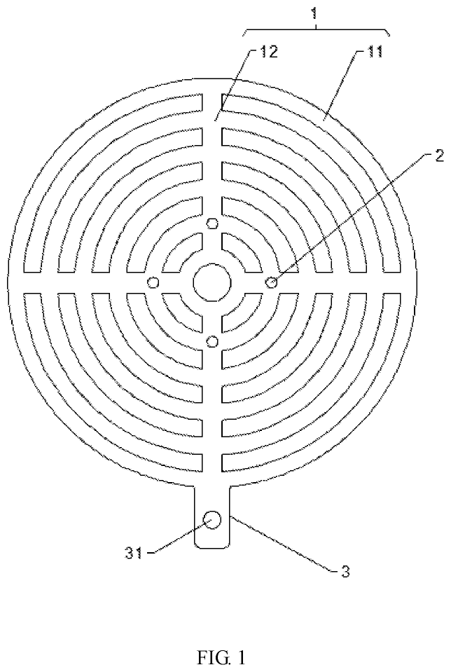

Referring to FIG. 1, the template comprises a mesh frame body 1 formed by staggering six concentric graphical bodies 11 which are tapered from the outside to the inside and four linear bodies 12 which are radiating outward from the center of the circle. In this Embodiment, the graphical bodies are annular bodies, the second circle of the concentric graphical bodies from the center of the circle is provided with four holes in a cross shape, and a magnetic member 2 (i.e. a NdFeB magnet) is embedded into each of the holes.

As shown in FIG. 1, a handle 3 is fixed on the outermost circle of the concentric graphical bodies in the template, and the handle is provided with a hole 31 at its center.

In the manufacturing process, the template can be integrally formed by injection molding of rubber or plastics, and then the magnet is embedded into the holes.

Of course, the template can also be made of iron by welding, and then the magnet is embedded into the holes.

### Embodiment 2

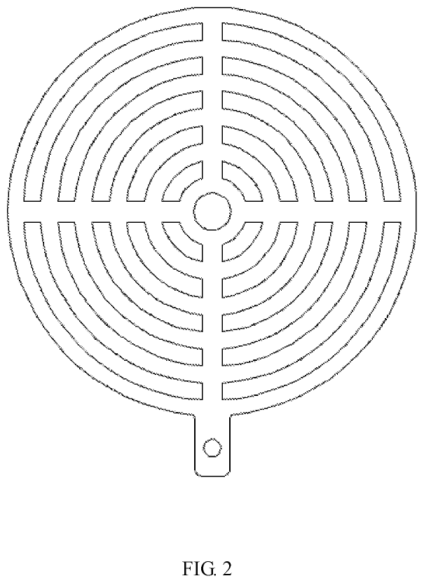

As shown in FIG. 2, this Embodiment differs from Embodiment 1 in that the magnetic member is mounted by spraying a soft magnetic material on outer surfaces of the concentric graphical bodies and the linear bodies to form a magnetic film layer.

### Embodiment 3

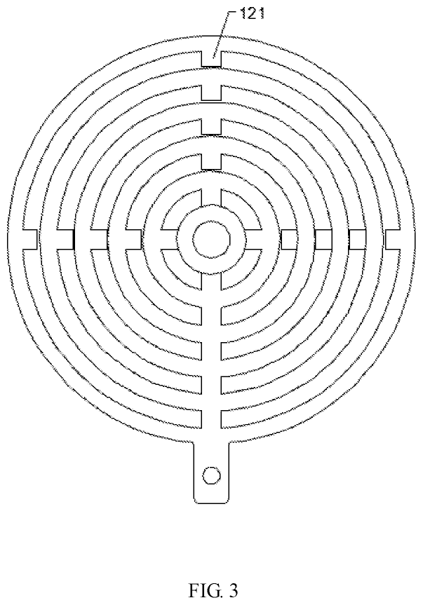

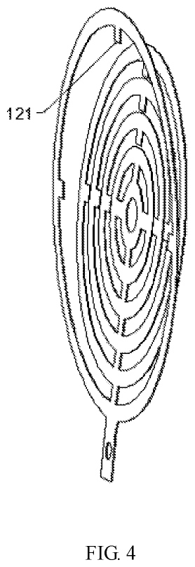

Referring to FIGS. 3 and 4, this Embodiment differs from Embodiment Embodiment 2 in that the linear bodies extending radially outward from the center of the circle are separated into a plurality of segments 121 by the concentric graphical bodies, and in the remaining linear bodies excluding the linear body at the bottom, lower ends of the segments between the adjacent concentric graphical bodies are disconnected from the neighboring concentric graphical body, and the other respective ends thereof are connected to the neighboring concentric graphical body.

In this Embodiment, the concentric graphical bodies and/or the radiating linear bodies are made of rubber or flexible ABS plastics, or spring steel.

The working process is as follows: an operator manually lifts up the outermost concentric graphical body to adjust the position of the outermost concentric graphical body and then change the included angle between planes of the outermost concentric graphical body and the adjacent concentric graphical body, thereby avoiding contacting fixing members such as bolts of a target plate; and where the target plate is not removed, the position of the concentric graphical bodies is adjusted to avoid contacting bolts or other fixing members on a target holder, thereby enabling vertical painting.

Of course, the above description only refers to specific application examples of the invention, and does not limit the protection scope of the invention in any way. Any technical solution formed by equivalent transformation or equivalent replacement falls within the claimed scope of the invention.

1. A magnetic painting template for a shooting target, comprising a mesh frame body and a magnetic member mounted on the body, the mesh frame body comprising a plurality of concentric graphical bodies which are tapered from the outside to the inside and linear bodies which are radiating outward from the center of the circle.

2. The magnetic painting template for a shooting target according to claim 1, wherein the magnetic member is made of a soft magnetic material or a hard magnetic material and mounted on the concentric graphical bodies or the radiating linear bodies.

3. The magnetic painting template for a shooting target according to claim 2, wherein the concentric graphical bodies or the radiating linear bodies are provided with holes to fix the block-shaped magnetic member made of a soft magnetic material or a hard magnetic material.

4. The magnetic painting template for a shooting target according to claim 1, wherein the linear bodies extending radially outward from the center of the circle are separated into a plurality of segments by the concentric graphical bodies, and in the remaining linear bodies excluding at least one linear body, respective ends of the segments between the adjacent concentric graphical bodies are disconnected from the neighboring concentric graphical body, and the other respective ends thereof are connected to the neighboring concentric graphical body.

5. The magnetic painting template for a shooting target according to claim 4, wherein the concentric graphical bodies and/or the radiating linear bodies are made of flexible materials.

6. The magnetic painting template for a shooting target according to claim 1, wherein the outermost concentric graphical body is provided with a handle.

7. The magnetic painting template for a shooting target according to claim 6, wherein the handle is provided with a hole.
